(19) United States
(12) Patent Application Publication
(10) Pub. No.: US 2026/0202813 A1
(43) Pub. Date: Jul. 16, 2026

(54) METHOD FOR GENERATING A CONTROL PROGRAM FOR A PROGRAMMABLE LOGIC CONTROLLER AND AUTOMATION SYSTEM

(71) Applicant: Beckhoff Automation GmbH, Verl (DE)

(72) Inventors: Aryaman Taore, Auckland (NZ); Fabian Bause, Delbrück (DE); Julian Lienen, Delbrück (DE); Johannes Schulze Everding, Sendenhorst (DE); Mahmoud Mohamed, Paderborn (DE)

(21) Appl. No.: 19/572,342

(22) Filed: Mar. 19, 2026

Related U.S. Application Data
(63) Continuation of application No. PCT/EP2025/059637, filed on Apr. 8, 2025.

(30) Foreign Application Priority Data
Apr. 19, 2024 (DE) 10 2024 110 997.1

(51) Int. Cl. G05B 19/05; G06F 8/35; G06F 11/34

(52) U.S. Cl. CPC G05B 19/056; G06F 8/35; G06F 11/3466

(57) ABSTRACT

A method is provided for generating a control program of a programmable logic controller in an automation system based on an AI pipeline that includes at least one AI model with optional pre-processing of input data and/or post-processing of output data. The following steps are carried out: providing a latency model for predicting a computation time for executing the AI pipeline based on hardware and software configurations, and a compatibility model for mapping AI pipeline functions to software configurations; detecting hardware and software configurations of the programmable logic controller; generating a set of AI pipeline candidates based on the compatibility model; selecting an AI pipeline by evaluating performance of the AI pipeline candidates after training, taking into account a predicted computation time based on the latency model; and generating a source code of the control program with the selected AI pipeline, for execution on the programmable logic controller.

### CROSS-REFERENCE TO RELATED APPLICATIONS

This application is a continuation of International Patent Application No. PCT/EP2025/059637, filed Apr. 8, 2025, entitled “Method for Generating a Control Program for a Programmable Logic Controller, and Automation System,” which claims priority to German patent application DE 10 2024 110 997.1, filed Apr. 19, 2024, entitled “Verfahren zur Erzeugung eines Steuerprogramms einer speicherprogrammierbaren Steuerung und Automatisierungssystem,” each of which is incorporated by reference herein, in the entirety and for all purposes.

### FIELD

The present application relates to a method for generating a control program for a programmable logic controller (PLC) in an automation system. The application further relates to a method for operating an automation system and an automation system.

### BACKGROUND

Machines or systems of an automation system are often frequently with the aid of programmable logic controllers (PLCs). The PLC may be an external device or software PLC. In order to control or regulate the actuators and sensors of the machine or system, the PLC usually uses a communication interface in the form of a fieldbus system. The actuators and sensors of the machine or system may then be networked with one another via the fieldbus system.

By reading out the measurement data from the sensors and/or the current actual data from the actuators connected to the inputs of the programmable logic controller, the PLC receives information about the status of the machine or system. The actuators are connected to the outputs of the programmable logic controller and allow for controlling the machine or system. For dynamic control of the actuators, the PLC generates the output data for the actuators based on the actual data and/or the measurement data from the sensors, wherein the aforementioned data may be individual values or groups of values. The actuators may also be controlled based on specifications, for example, using profiles of movement.

In order to provide the desired operating mode of the machine or system, the control task of the PLC determines which output data generated by the PLC, depending on the corresponding input data, is fed to the actuators. The PLC usually processes the data cyclically in three steps: providing current input data (e.g. actual data from the actuators and/or measurement data from the sensors), processing the input data into output data, and outputting the output data for movement control (e.g., target positions, etc.).

Industrial PLCs are deterministic real-time systems. Determinism here refers to the requirement that an event or calculation must be completed within a defined time interval. These time intervals are defined by the specific applications of the respective automation system. Programmable logic controllers usually require hard real-time capability, which means that deadlines must be consistently met and never exceeded. In addition, a valid result must be available for the actuators at the time of the deadline. This is particularly relevant if exceeding the deadline could result in personal injury or property damage, for example if a robot arm is not braked in time.

In some applications of automation systems, algorithms based on artificial intelligence (AI), also known as AI models, are also executed on the corresponding PLC. In this context, the term AI model primarily refers to neural networks, but the term is also intended to include statistical models such as linear models, support vector machines, decision trees, or random forests. AI may improve the efficiency of the PLC, particularly in the area of sensor data processing, for example in image processing, or allow for certain functions in the first place.

In view of the above-mentioned aspect of the real-time capability of the PLC, it is necessary to integrate the AI models used into the runtime environment of the PLC in such a way that the requirements for both latency and determinism may be met. A guarantee of the operability of a selected AI model in the context of the given deterministic environment and prior to its implementation is therefore desirable, but not known in the prior art.

### SUMMARY

The application provides an improved method for generating a control program for a programmable logic controller (PLC) in an automation system or for operating an automation system as well as a corresponding automation system.

It is to be noted that all features mentioned in context with the disclosed method may also be embodiments of the disclosed automation system, and vice versa.

### EXAMPLES

In order to generate a control program for a programmable logic controller in an automation system based on an AI pipeline that contains at least one AI model with optional pre-processing of input data and/or post-processing of output data, the following steps are carried out: providing a latency model for predicting a computation time for executing an AI pipeline based on hardware configurations and software configurations, and a compatibility model for mapping AI pipeline functions to software configurations; generating a set of AI pipeline candidates based on the compatibility model; detecting a hardware configuration and a software configuration of the programmable logic controller; selecting an AI pipeline from the set of AI pipeline candidates by evaluating a performance of the AI pipeline candidates after training the AI pipeline candidates, taking into account a prediction of a computation time based on the latency model; generating a source code of the control program with the aid of the selected AI pipeline for execution on the programmable logic controller in the automation system.

When integrating AI models or AI pipelines into the control system, the latency of the model for a given hardware specification must be taken into account during model training. Furthermore, it is necessary to integrate the AI model into the runtime environment of the PLC so that requirements for both latency and determinism may be met.

The latency model may determine latency in the form of a numerical value resulting from the sum of the runtimes of the executed AI pipeline functions. AI pipeline functions are usually operators or sequences of operators.

The latency model is capable of predicting the latency of AI pipelines. The latency model takes into account not only the hardware configuration but also the software configuration of the target system to predict the execution time.

The compatibility model may be used to provide a data structure in which AI pipeline functions are assigned equivalent functions in the software configuration. The compatibility model ensures that no AI pipeline candidates are generated that cannot be executed on a specific target system.

When selecting and training AI model candidates, it is not usually checked whether the AI model is executable on the target system. Hardware specifications are taken into account, but this alone is insufficient to verify actual operability. With the compatibility model, which takes into account both the hardware configuration and the software configuration of the target system, operability is inherently guaranteed.

Guaranteed operability also allows for automating inference code generation. Since the AI pipeline also optimizes pre- and/or post-processing steps, the AI model is augmented.

The set of AI pipeline candidates may be generated using at least one application-specific training data set.

Combinatorial possibilities of sequences of operators are considered, wherein only operators that are compatible with the target system according to the compatibility model are used. This results in a search graph with various possible paths.

The compatibility of the AI pipeline candidates is already ensured in this step. During generation, not only different AI models are taken into account, but also pre- and/or post-processing steps. In this context, as well, the compatibility model ensures the executability of the operators considered.

A one-shot neural architecture search method may be used to generate the set of AI pipeline candidates.

When selecting the AI pipeline, the generalizing capability of the AI pipeline may be taken into account from the set of AI pipeline candidates.

A Pareto optimality method may be used to select the AI pipeline from the set of AI pipeline candidates.

The selected AI pipeline may be retrained with a training dataset to improve its generalization ability.

If, when selecting the AI pipeline from the set of AI pipeline candidates, no pipeline candidate meets a specified latency requirement, the hardware configuration and/or software configuration may be adjusted.

The AI models for the AI pipeline candidates may be selected from the group of neural networks, statistical models, support vector machines, decision trees, and/or random forests.

In order to operate an automation system, the source code of the control program is further loaded onto the programmable logic controller. The control program may then be executed to carry out an automation task. An automation system for carrying out an automation task may thus be operated.

The application is described in more detail below with reference to the accompanying schematic and not-to-scale drawings.

### BRIEF DESCRIPTION OF THE DRAWINGS

The figures (FIGS.) in the drawings, which are merely examples, show:

FIG. 1 is a schematic view of an embodiment of an automation system;

FIG. 2 is a schematic view of an embodiment of a method for generating a control program for a programmable logic controller of the automation system;

FIG. 3 is a schematic view of a neural network model;

FIG. 4 is a schematic depiction of a search graph for an AI pipeline candidate;

FIG. 5 is a schematic depiction of an AI pipeline candidate; and

FIG. 6 is a schematic depiction of the performance of various AI pipeline candidates.

### DETAILED DESCRIPTION

The following definitions are used below:
AI pipeline: Consists of an AI model and optional pre-processing of the input data or optional post-processing of the output data.
Training: Optimization of an AI model consisting of a series of adjustable parameters that uses a suitable method to determine the parameter combinations that minimize a loss function for a given data set. Differentiable AI models (usually artificial neural networks) are considered, which are optimized using gradient descent methods (specifically backpropagation) on supervised training data (features and labels).
Latency: Time delay between requesting a prediction from a model and receiving the prediction. This includes, among other things, the calculation of the model itself, but also any overheads due to communication with the execution environment, memory accesses, and communication between individual execution units.
Real-time capability: Requirement that an event or calculation be completed within a defined time interval.
Operability: Capability of executing an AI model or AI pipeline on a target system, defined by the mapping capability of all operators of the AI model or AI pipeline to a semantically equivalent function on the target system.
Compatibility: If an AI model or AI pipeline is operable on a target system, then the AI model or AI pipeline and the target system are compatible with each other.
Generalizing ability: The ability of an AI model or AI pipeline to make accurate predictions (i.e., predictions that correspond as closely as possible to the underlying truth) on previously unseen data. If an AI model is trained on training data, the AI model should function as error-free as possible later on in an application on newly generated, previously unseen data by learning basic concepts that may be applied in a generalized way to new data and that reflect the underlying relationships between features and labels.

In the following, the structure and functioning of an automation system with a programmable logic controller (PLC), as well as a method for generating a control program for a programmable logic controller (PLC) in the automation system and a method for operating the automation system are schematically described. Corresponding reference numerals are used for corresponding features.

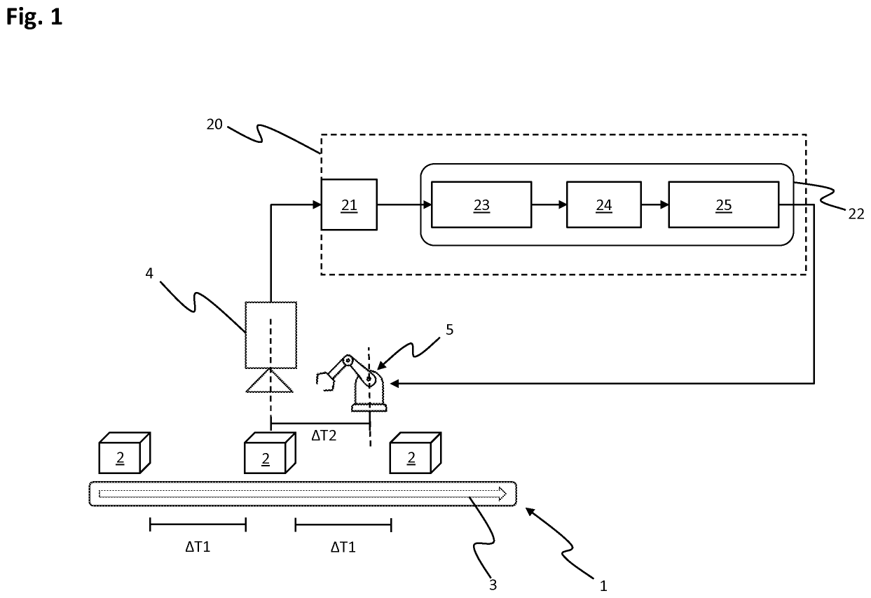

FIG. 1 shows an exemplary automation system 10 which in the configuration shown is part of a packaging machine. The automation system 10 comprises a conveyor belt 1 on which packaging units 2 are transported in the direction of the arrow 3, and a programmable logic controller (PLC) 20 which controls processes in the automation system 10 to be described below. A control program is installed on the PLC 20 for this purpose. The PLC 20 is technically described by a hardware configuration and a software configuration.

The hardware configuration includes components such as the motherboard, microprocessors (CPU), memory modules (RAM), graphics processors (GPU), and so on. The software configuration of the PLC 20 includes information such as the type and version of the operating system used, the type and version of the control program, for example the TwinCAT automation software, specifications on required and/or available software libraries for carrying out various tasks of the PLC 20, and further software-specific features. In the context of this disclosure, the joint specification of hardware and software is also referred to as the target system in connection with the creation of a control program for the PLC 20.

The automation system 10 also comprises a sensor device 4, which comprises, for example, a camera and/or a scale, and an ejection station 5. The sensor device 4 and the ejection station 5 are parts of a device for inspecting the packaging units 2. The inspection checks whether the individual packaging unit 2 generated meets certain specified quality requirements.

For the purposes of this description, it is assumed that each of the packaging units 2 is classified as binary by the inspection, i.e. assigned to one of the categories OK or not OK, based on criteria such as visually detectable damage, dimensions to be complied with, presence or absence of labeling, a prescribed weight, etc. If a packaging unit 2 is found to be not OK, it is sorted out of the system at the ejection station 5, for example removed from the conveyor belt 1, while the packaging units 2 that fall into the OK category remain on the conveyor belt 1 and are further processed in a manner. The binary classification serves only as a simplified example here. The classification could also be much more complex and, for example, include a large number of different quality levels or a hierarchical structure with main classes and subclasses.

The packaging machine processes two packaging units 2 in a specific first time period ΔT1, which is indicated in FIG. 1 as the distance between the packaging units 2. The first time period ΔT1 may be, for example, 200 ms. A maximum permissible decision time ΔT2, within which a decision must be made as to whether the individual packaging unit 2 is OK or not OK, has a value that is generally slightly smaller than the first time period ΔT1 and depends, among other things, on the structural distance between the sensor device 4, for example the camera, and the ejection station 5. The maximum permissible decision time ΔT2 may be, for example, 150 ms. After the maximum permissible decision time ΔT2 has elapsed, the result of the classification of the individual packaging unit 2 detected by the camera 4 must be securely available in the PLC 20 so that the PLC 20 may supply the ejection station 5 with the corresponding control commands.

As already mentioned at the beginning, the PLC 20 is a deterministic real-time system. The maximum permissible decision time ΔT2 therefore defines a time interval that must be consistently adhered to and must never be exceeded, as otherwise downstream processes of the continuously or quasi-continuously operating automation system 10 would be impaired. In connection with the example shown in FIG. 1, a process for classifying packaging unit 2 that may reliably provide the result within the maximum permissible decision time ΔT2 is also referred to as real-time capable.

The sensor device 4 is connected to the PLC 20 via a suitable interface 21, which is embodied to interpret the sensor signals or data transmitted by the sensor device 4. In this context, “interpreting” means carrying out the classification described above on the basis of the sensor data.

For this purpose, artificial intelligence (AI) methods are used, which are implemented as algorithms or software modules or programs on the PLC 20 and are also referred to as AI models in the context of the present disclosure. With the help of the AI models, the PLC 20 is able to carry out tasks such as the classification of the packaging units 2 in such a way that random changes in the boundary conditions that are irrelevant to the task, such as—in the case of an optical inspection—a change in ambient lighting conditions or a variable orientation of a packaging unit 2 on the conveyor belt 1 do not influence the classification result. The result output by the AI model, its output, is also referred to as a prediction.

In the prior art, a large number of AI models are known, each of which may be based on different mathematical models (e.g., artificial neural networks) and place different demands on the hardware and/or software configuration of the PLC 20 or deliver different performance with certain hardware and/or software configurations, i.e., provide predictions at different speeds and/or with different degrees of accuracy.

In its function within the PLC 20, the AI model is also integrated in terms of software into a so-called AI pipeline, which is labeled as AI pipeline 22 in FIG. 1. The AI pipeline comprises the AI model used and, as the case may be, pre-processing steps for input data and/or post-processing steps for output data. In the embodiment shown in FIG. 1, the AI pipeline 22 comprises the AI model 24 as well as a pre-processing step 23 of the sensor data provided by the sensor device 4 and a post-processing step 25 of the output issued by the AI model 24.

Neural networks are primarily used as the AI model. However, the AI model may also be another (classical) statistical model, such as a linear model, support vector machine, decision tree, random forest, etc.

If the classification of packaging units 2 is based on image evaluation, the AI model 24 may be implemented as an image classifier. The pre-processing step 23 may then be, for example, that the input images provided by the sensor device 4 are pre-processed in a certain way. In the example of an image classifier, a pre-processing step may be, for example, changing the image size of an input image (resize image) or adjusting the saturation of the input image. The post-processing step 24 may then be, for example, converting the predictions of the AI model 24 into a different representation. In the example of an image classifier, a post-processing step may be, for example, selecting the class with the highest probability or determining the modal value of the probability distribution after the output from the AI model.

With regard to the automation system 10 and the creation of a control program for the PLC 20, one challenge is to select the AI pipeline 22 for the respective task in the automation system 10, in the present example for the classification of the packaging units 2, and for a given target system of the PLC 20, and to integrate it into the runtime environment of the PLC 20 in such a way that a guarantee of operability and a guarantee of the real-time capability of the control program may be given in advance.

Operability guarantee means that even before an AI pipeline is integrated into a PLC, it is guaranteed that the selected AI model may be executed by the target system of the PLC.

It is desirable to provide a control program that is optimized for the respective automation system or the specific PLC.

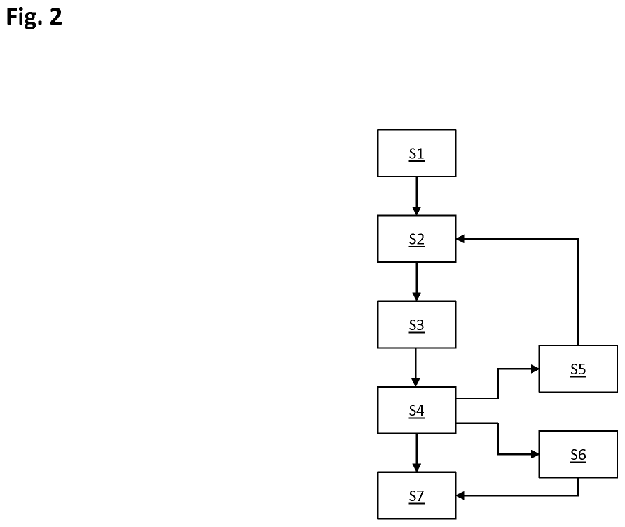

The method disclosed below for generating a control program for the PLC 20, which is shown schematically in FIG. 2, is executed at least in part as a computer-implemented method on the automation system 10 itself or on an external computer.

In a first step S1, a latency model and a compatibility model are provided. The latency model is understood as a function that maps the specific AI pipeline and the target system to a numerical value, the latency. Latency refers to the computing time required to execute the AI pipeline on the target system under the given hardware and software conditions. The latency model may be used to predict the latency of AI pipelines that are not specifically known at the time the latency model is generated.

The AI models of the AI pipelines may be described as sequences of operators. Operators are elementary mathematical operations, such as convolution operators or activation functions, which are known to be used for the specification of AI models. The operators form the basic building blocks of AI models and are used in a wide range of AI models. By selecting from the multitude of operators or combining the operators in different ways, previously unknown AI models may be assembled.

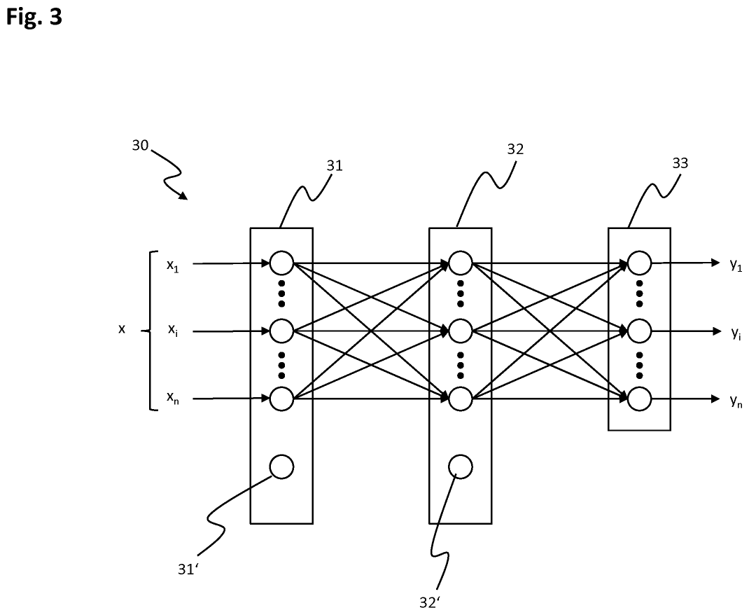

For example, an artificial neural network 30, as a special form of an AI model, may be structured as shown schematically in FIG. 3. In the representation in FIG. 3, an input vector x, which is represented by the values x₁, xᵢ, xₙ is processed schematically from left to right in the neural network 30.

The neural network 30 shown in FIG. 3 is an MLP (multilayer perceptron) type neural network, which in a known manner consists of three layers, an input layer 31, a hidden layer 32, and an output layer 33. The hidden layer 33 may in turn be composed of a plurality of layers. Each neuron in a layer is connected to each neuron in the next layer, with each connection having a numerical value referred to as a weight. The MLP network has a feedforward architecture in which information flows through the network in only one direction, without feedback loops or cyclic connections.

MLP networks are used in particular in prediction applications. Alternatively, RBF (radial basis function) type neural networks may also be used, for example.

Each of the three layers, the input layer 31, the hidden layer 32, and the output layer 33, forms an operator, wherein the input layer 31 and the hidden layer in the example each represent a matrix multiplication with a first bias 311 and a second bias 321, and the output layer 33 represents a matrix multiplication without bias.

The runtime of the calculation of such operators in an artificial neural network 30 may vary greatly from target system to target system, depending on the specific hardware and software configuration. Therefore, the runtime of the respective operators is determined depending on the hardware and software configuration recorded in the second step S2.

The latency of the AI pipeline is then determined as the sum of the runtimes of the operators of the AI model and, in addition, the runtimes of pre- and post-processing. It is also possible to describe pre- and post-processing with operators and then determine their runtime.

In the specific example in FIG. 1, the latency of the neural network 30 shown in FIG. 3, which together with post- and pre-processing defines the AI pipeline 22, is determined on the given target system (ZS) by the following calculation rule:

$$Latency ( KI - Pipeline , ZS ) = Runtime ( MatMultBias , ZS ) + Runtime ( MatMultBias , ZS ) + Runtime ( MatMult , ZS ) + Runtime ( Pre - Processing , ZS ) + Runtime ( Post - Processing , ZS ) \qquad ( Equation 1 )$$

Latency (AI pipeline, ZS) is to be read here as the latency of the AI pipeline under consideration on the target system ZS under consideration. The abbreviation MatMult stands for the matrix multiplication operation described above, MatMultBias for matrix multiplication with bias.

In order to determine the latency on a target system, the runtimes of the operators, for example MatMultBias, are first measured on a number of different target systems and stored in a database.

The hardware configuration of a target system may include, for example, a specific type of personal computer (PC), a specific microprocessor used in the PC, such as an Intel Core i7 CPU, and a specific memory configuration, such as 16 GB of DDR4 memory. The software configuration of a target system includes a version of the operating system running on the PLC 20, such as a Microsoft Windows operating system version, a version of the software running on the PLC 20, such as a basic TwinCAT system, and a version of certain software libraries executed by the PLC 20, such as a TwinCAT Vision version. In addition, such a description may also include the parameterization of a specific execution mode, for example, with or without multi-threading, use of an AI accelerator, etc.

Table 1 below shows examples of the runtimes for the MatMultBias and MatMult operators for selected hardware and software configurations. The hardware configuration in the example is PLC type C6030 with a CPU Core i7-11850HE. For the software configuration TwinCAT version 3.2.7, the runtime for the operator MatMultBias is 0.003 s (line 1) and MatMult the runtime for the operator MatMult is 0.002 s (line 2). For the software configuration TwinCAT version 3.2.1, the runtime for the operator MatMultBias is 0.006 s (line 3).

TABLE 1
Examples of runtimes for selected hardware
and software configurations

| Target system | | | | | |
|---|---|---|---|---|---|
| PLC | | TwinCAT | | | Runtime |
| type | CPU | version | . . . | Operator | [in s] |
| C6030 | Core i7- | 3.2.7 | . . . | MatMultBias | 0.003 |
| | 11850HE | | | | |
| C6030 | Core i7- | 3.2.7 | . . . | MatMult | 0.002 |
| | 11850HE | | | | |
| C6030 | Core i7- | 3.2.1 | . . . | MatMultBias | 0.006 |
| | 11850HE | | | | |

With the aid of a database generated in this way, the latencies of AI models may now be calculated according to the individual operators of the associated AI models, taking into account the target system. For operators that are not included in the database for the given target system, runtimes may be interpolated based on similarities of certain attributes.

The runtimes of pre-processing and post-processing, if they may be described with operators, may also be determined in this way.

In addition, a latency model may also take into account contextualization of operator sequences, something that a target system may summarize by carrying out two MatMult operations in succession, thereby executing them particularly efficiently. This allows more complex latency relationships to be modeled compared to simply summing operators (see Equation 1).

Instead of a database-based determination, in which a previously measured runtime is determined for each operator or operator sequence of the AI model, which is then accumulated to latency, (learned) AI models (such as neural networks) may also be used in latency model determination. Here, too, the AI models may map more complex latency dependencies between sequences of operators, so that, as in the example mentioned above, two MatMult operators may be combined by an AI accelerator, and the resulting latency on the selected target system is then less than the sum of the two individual latencies.

The latency model may thus be used to predict the expected latency for each AI pipeline for carrying out an automation task in the automation system, taking into account the software and hardware configuration of the target system.

As mentioned above, the first step S1 also provides a compatibility model of the automation system. This is advantageous because known AI models often use operators that are not necessarily supported on every target system. For example, the latest AI operators, such as transposing a matrix, are only supported in software platforms such as newer versions of automation software after a slight delay, meaning that an AI model that uses such an operator would simply not be executable on certain target systems, regardless of factors such as the runtime of the operator or the latency of the AI pipeline. This also applies to pre-processing and post-processing when these are described with the aid of operators.

To avoid selecting an AI model or AI pipeline that places unfulfillable demands on the target system in this sense, the compatibility model ensures that no candidates for the AI model or AI pipeline are generated that cannot be executed on the specific target system. The compatibility model is a rule-based model that maps functions of the AI model or AI pipeline to functionally equivalent functions of the target system. Here, too, the contextualization of operator sequences may be considered, for example, that a single function of an AI pipeline has no equivalent to a function of the target system, but does when combined sequentially with another operator.

This may be understood as a type of database, the structure of which is illustrated in Table 2 below. Table 2 shows the corresponding equivalent function for the operators MatMultBias, MatMult, and imageResize (changing an image size) for the hardware and software configuration of the target system, line by line. The hardware configuration of the target systems in the example is PLC type C6030 with a CPU Core i7-11850HE. The software configuration of the target systems is at least TwinCAT version 3.2 or at least TwinCAT version 3.2.1. The operator MatMultBias is assigned TwinCAT MatMultBias (line 1) as its target function, the operator MatMult is assigned TwinCAT MatMult (line 2) as its target function, and the operator imageResize is assigned TwinCAT imageResize (line 3) as its target function.

TABLE 2
Equivalent function for operators MatMultBias,
MatMult, and imageResize

| Target system | | | | | |
|---|---|---|---|---|---|
| PLC | | TwinCAT | | | Target |
| type | CPU | version | . . . | Operator | function |
| C6030 | Core i7- | >=3.2 | . . . | MatMultBias | TwinCAT |
| | 11850HE | | | | MatMultBias |
| C6030 | Core i7- | >=3.2 | . . . | MatMult | TwinCAT |
| | 11850HE | | | | MatMult |
| C6030 | Core i7- | >=3.2.1 | . . . | ImageResize | TwinCAT |
| | 11850HE | | | | Vision Resize |

If an operator does not have a corresponding target function on a target system, the corresponding field may e.g. remain empty or contain the entry “not available.

The compatibility model is a rule-based model that checks whether an AI model or AI pipeline and a description of the target system may be executed or operated on the target system, thereby determining the compatibility between the AI model and the target system. The compatibility model is used, for example, to check whether the software libraries in the target system, e.g. TwinCAT Vision for real-time execution, support certain operators.

Instead of a database-based determination, however, (learned) AI models (such as neural networks or large language models) may also be used in the compatibility model determination.

In a second step S2 of the process for generating a control program for the PLC 20, which is shown schematically in FIG. 2, the specific hardware configuration or software configuration of the automation system 10 is then recorded. This may be done automatically by software or via a user interface (human-machine interface, HMI) and interaction with a user.

Based on the recorded hardware configuration and software configuration, a set of suitable AI pipeline models is then generated in a third step S3, using the compatibility model. For this purpose, a large number of different AI pipelines are generated that are suitable as candidate solutions. Various combinatorial possibilities of sequences of operators are generated, wherein only those operators are used that are compatible with the recorded hardware configuration or software configuration of the target system according to the compatibility model.

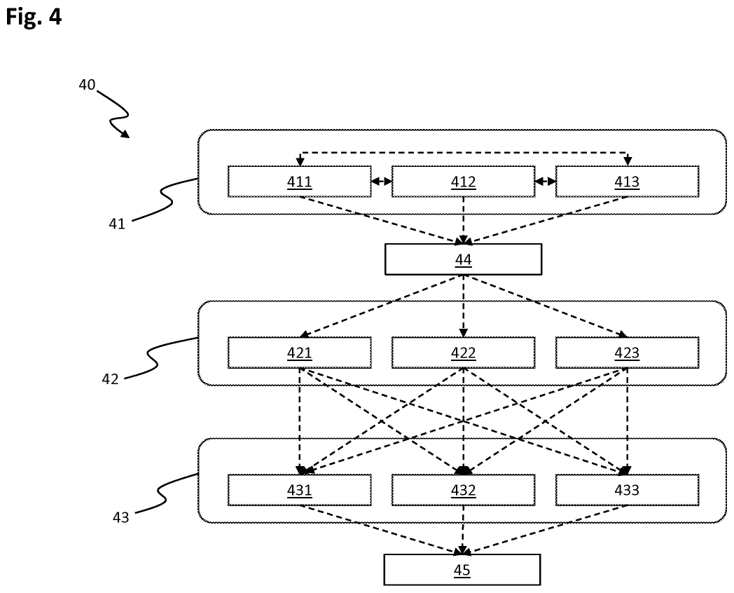

As shown schematically in FIG. 4, this process may be represented as a search graph 40 the operators of which are connected via various path options represented as dashed arrows. The search graph 40 shown in FIG. 4 refers to the automation system 10 shown in FIG. 1, which is part of a packaging machine.

The first layer 41 of the search graph 40 contains pre-processing steps. With regard to an image of a packaging unit 2 transmitted by the sensor device 4, this may e.g. be, as already indicated above, an adjustment of an image size 411 (resize), as well as an increase 412 or a decrease 413 of an image saturation value. A second layer 42 and a third layer 43 are arranged between a model input 44, which comprises the input of the input vector of the AI model, and a model output 45 (the output). These each contain various operators that are required to carry out the task to be solved, for example, the classification task of the automation system in FIG. 1, such as matrix multiplication 421, 431, matrix multiplication with bias 422, 432, and identity operator 423, 433.

In FIG. 4, the search graph 40 may include additional operators and layers, such as a layer that includes post-processing steps. A specific path through the search graph 40 results in an AI pipeline that, according to the compatibility model, represents a possible AI pipeline candidate that is compatible with the target system.

To ensure that possible AI pipeline candidates are suitable AI pipeline candidates, the AI models of the possible AI pipeline candidates are trained using a task-specific training data set and then evaluated on a validation data set that was previously separated from the training data set.

In the example in FIG. 1, a training dataset for a visual inspection could, for example, comprise images of packaging 2 with an annotation (labels) that identifies the packaging 2 depicted as belonging to one of the categories OK and not OK in the sense of a ground truth.

The appropriate AI models themselves are in turn determined using an AI algorithm, such as a graphical neural network model. Libraries may be used to generate candidates for AI models, which are then considered as part of the AI pipeline candidates. When generating the AI pipeline candidates, not only are different AI models taken into account, but also the (dataset-specific) pre- and post-processing steps.

While any AI models and/or AI pipelines could in principle be generated as candidates, generation may be limited to a one-shot neural architecture search (see, for example, Zichao Guo et al.: Single Path One-Shot Neural Architecture Search with Uniform Sampling, in https://arxiv.org/abs/1904.00420). For this purpose, a search space in the form of a directed acyclic graph (DAG) may be selected that only contains operators that are compatible with the target system. Then, in each training iteration, which corresponds to a specific adjustment of the model based on the training data, paths in the DAG are sampled and optimized using backpropagation with the aid of classical cost functions. Some of the blocks selected during sampling may appear in a plurality of candidates, so that their optimization implicitly influences the optimization of other candidates. As a result, optimized parameters or weights of the model are shared, leading to what is known as weight sharing. A task-specific data set or a combination of such data sets is used for training. After completion of this initial training, the entire optimized search space in the form of the DAG, in which each path represents a specific neural network, represents the set of candidates that are compatible with the target system.

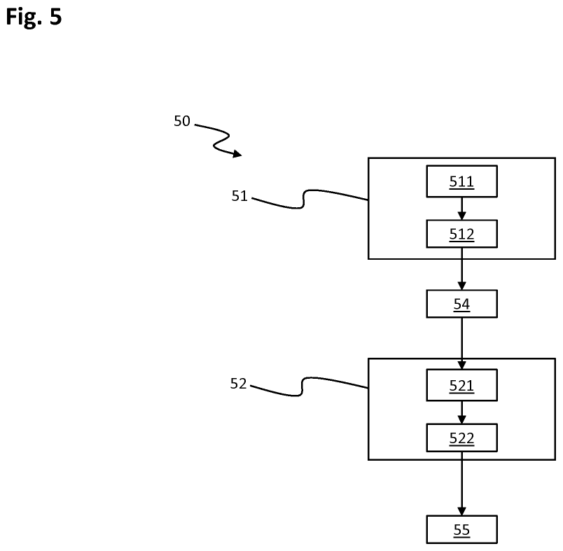

FIG. 5 shows an example of a generated AI pipeline candidate 50 that was found using the search graph 40 shown in FIG. 4 and a graphical neural network. A pre-processing layer 51 contains the operators image size adjustment 511 (resize) and image saturation value increase 512. As described in connection with FIG. 4, the model input 54 corresponds to the input of the input vector of the AI model. The AI model 52 itself contains the first operator 521 of matrix multiplication with bias and the second operator 522 of matrix multiplication without bias. Furthermore, the AI pipeline candidate 22 includes a model output 55. A possible post-processing layer would follow immediately after the model output 55.

AI pipeline candidate generation identifies a plurality of different AI pipelines that are suitable as solution candidates, wherein comprehensive training of all potential model candidates has already been completed. The compatibility model ensures that only AI pipeline candidates that are fundamentally capable of running on the selected target system are generated.

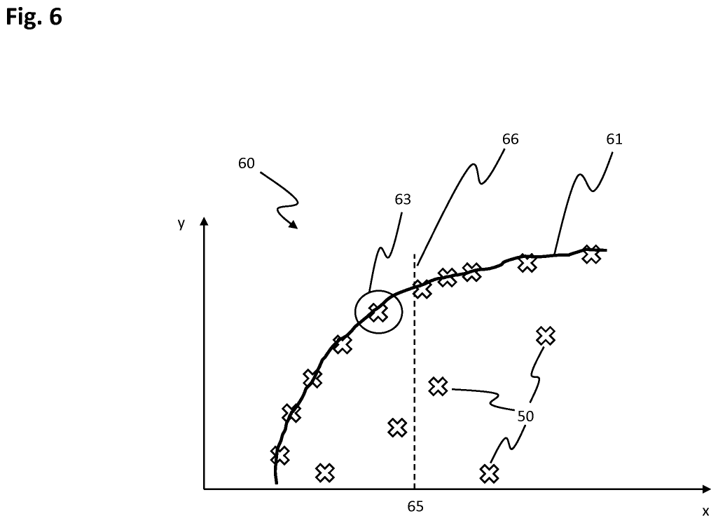

In a fourth step S4, an AI pipeline is now selected from the set of suitable AI pipeline candidates for use in the control program of the PLC 20, which is described below with reference to FIG. 6.

The AI models of the AI pipeline candidates are trained using additional, particularly extensive task-specific training data sets. As is well known in the technical field of AI, training is carried out using suitable feedback loops and algorithms, for example using residuals and cost functions. Training the AI models may improve their generalization ability. Their latency remains unchanged, as only the weights of the model are changed, not the model architecture.

Each AI pipeline candidate 50, represented by a cross in diagram 60 of FIG. 6, comprises a latency, i.e. the resulting computing time required to execute the AI pipeline on the target system under the given hardware and software conditions. The latency is plotted on the abscissa (x) in diagram 60. As described above, this latency may be calculated as the sum of the runtimes of the individual operators used in the AI pipeline using the latency model.

Each of the AI pipeline candidates 50 also has a generalization ability, which is plotted on the ordinate (y) in diagram 60. In general terms, generalization ability may be understood as the ability of an AI model to make accurate (i.e., as close to the fundamental truth as possible) predictions on previously unseen data. So, if an AI pipeline candidate 50 is trained on training data, this model should also function as error-free as possible in an application on newly generated, previously unseen data by learning basic concepts that may be applied in a generalized way to new data and reflecting the underlying relationships between features (in the example, packaging units 2) and labels (in the example, OK or not OK). In relation to the diagram, the generalization ability may also be interpreted as the accuracy of the predictions made by the respective AI pipeline candidate 50 as to whether packaging units 2 are OK or not OK. Corresponding metrics for generalization ability are known in the state of the art.

The horizontal and vertical position of the individual AI pipeline candidates in diagram 60 thus reflects their performance in terms of latency (the further to the left in the diagram, the better, as latency is lower) and their generalization ability (the further up in the diagram, the better, as generalization ability is higher).

To evaluate the latency of the individual AI pipeline candidates, a latency requirement resulting from the real-time constraints of the automation system 10 represented in diagram 60 by a value 65 and a corresponding dashed vertical line 66, is compared with the expected latencies of all AI pipeline candidates considered, as contained in the latency model.

The latency requirement 65 for the AI pipeline 22 to be selected, in terms of the maximum time available for generating a prediction, in the example in FIG. 1 corresponds to the maximum permissible decision time ΔT2 of 150 ms, reduced by a period of time for other processes that must also run during this period, such as status checks of the discharge station 5, control of the conveyor belt 1, and the like. In this example, 50 ms of computing time is assumed for these tasks, so that the latency requirement for the AI pipeline 22 is 100 ms (150 ms-50 ms=100 ms).

All AI pipeline candidates that have a higher latency than the latency requirement 65, i.e. those shown in diagram 60 to the right of the dashed vertical line 66, are rejected in the fourth step S4 and are not considered for use in the control program of the PLC 20. From the remaining AI pipeline candidates, so-called Pareto-optimal candidates may first be sought. In this context, a candidate is described as Pareto-optimal if, in terms of its generalization ability and latency properties, it is not surpassed by any other candidate in terms of a simultaneous improvement in generalization ability and latency, i.e., if it would improve both quality characteristics at the same time.

The set of Pareto-optimal candidates is arranged along the Pareto front 61 shown in diagram 60. From this set of AI pipeline candidates, the one with the highest generalization ability and a latency lower than the latency requirement 65 is then typically selected as the AI pipeline 22 for use in the control program of the PLC 20. In diagram 60, this AI pipeline candidate is marked by the circled cross 63.

As an alternative, the selection of the AI pipeline 22 from the set of AI pipeline candidates in the fourth step S4 may also be carried out by a user. This may be done, for example, by presenting the user with certain metrics and details of the AI pipeline candidates on an HMI during the execution of the procedure, such as the latencies of the AI pipeline candidates, a metric for their generalization ability, the type of AI model used for each AI pipeline candidate, its energy efficiency, and/or the software libraries used. The user then has the opportunity to manually set certain weightings in the selection algorithm via the HMI interface or to select an AI pipeline candidate themselves.

In configurations of the target system in which no AI pipeline model that meets the latency requirement is found in the fourth step S4 during candidate selection, the hardware and/or software specification of the target system is adjusted in a fifth step S5. A suggestion for this adjustment may be made to a user based on a database in which various hardware and/or software specifications with corresponding performance data are stored.

If, for example, it is determined in the fourth step S4 that the AI pipeline candidates generated in the third step S3 are very complex and therefore run too slowly on a given CPU, the fifth step S5 may involve switching to a computer with a faster processor and faster graphics card as hardware, and to a more powerful software library.

Therefore, in this case, as indicated in FIG. 2, after making the changes to the hardware and/or software configuration, the process is repeated in a loop starting from the second step S2 by recording the changed hardware and software configuration in the second step S2, a set of suitable AI pipeline models is generated in the third step S3 based on the compatibility model, and in the fourth step S4, an AI pipeline is selected from the set of suitable AI pipeline candidates for use in the control program of the PLC 20.

Furthermore, the AI pipeline 22 selected in the fourth step S4 may be retrained in a sixth step S6 using application-specific data sets in order to improve its generalization ability. Here, too, the latency remains unchanged. The reason for this step is that the AI pipeline 22 selected in the fourth step S4 may not have been sampled often enough during training during the joint optimization, so there is still potential for optimization in terms of the generalization ability of the AI pipeline 22.

In a seventh step S7, a source code of the control program of the PLC 20 of the automation system 10 is generated using the AI pipeline 22 selected in the fourth step S4. In this process, the AI pipeline 22 is exported from the AI training environment into target system-compatible PLC source code and saved. The PLC source code is integrated into the PLC environment of the PLC 20.

The PLC source code is generated in such a way that operators for AI pipeline execution, such as pre-processing steps, are mapped to software-specific library functions, such as TwinCAT library functions, which is a step the feasibility of which is guaranteed by the compatibility model. With its deterministic cyclic execution, the control program of the PLC 20 ensures that calculation results are available at the expected time.

The PLC code generated in the seventh step S7 is executed on the PLC 20 during operation of the automation system 10, so that the PLC may reliably predict the task to be solved using the AI pipeline 22, in the example the classification of the packaging units 2, within the specified maximum latency.

The presented method is also capable of optimizing the pre- and post-processing steps. The compatibility model allows for mapping such optimized operators to specific software functions, which then allows the PLC code to be generated automatically in the seventh step S7.

Furthermore, as described above, the latency model may be used to take into account details of the execution environment (such as an ONNX runtime (Open Neural Network Exchange) and its configuration, a TwinCAT version, an operating system, etc.) may be taken into account, since the PLC code generated in the seventh step S7 may be provided to the user with a specific software configuration that may ultimately be delivered as an image for the target system. This also implicitly allows for optimizing an execution environment, including software specifications for a given model.

The use of the latency model always guarantees the real-time capability of the generated control program. The compatibility model, which takes into account both hardware and software specifications of the target system, also ensures operability. Operability is therefore inherently guaranteed, and a situation in which the source code of the PLC control program generated in the fifth step S5 cannot be carried out in the selected configuration of the target system due to hardware incompatibility may be ruled out.

The application is not limited to the embodiments described and illustrated. Rather, it also encompasses all technical developments within the scope of the application defined by the patent claims. In addition to the embodiments described and illustrated, further embodiments are conceivable which may comprise further modifications and combinations of features.

Although the invention has been further illustrated and described in detail by embodiments, the invention is not limited by the disclosed examples and other variations may be derived therefrom by those skilled in the art without departing from the protective scope of the invention.

TABLE 3
References

| | |
|---|---|
| ΔT1 first time period | 41 Pre-processing |
| ΔT2 decision time period | 42 Decision block 1 |
| 1 conveyor belt | 43 Decision block 2 |
| 2 packaging unit | 44 Model input |
| 3 arrow | 45 Model output |
| 4 sensor device | 50 AI pipeline candidate |
| 5 discharge station | 51 Pre-processing layer |
| 10 automation system | 52 AI model |
| 20 programmable logic controller (PLC) | 54 Model input |
| 21 Interface | 55 Model output |
| 22 AI pipeline | 60 Diagram |
| 23 Pre-processing | 61 Pareto front |
| 24 AI model | 65 Latency request |
| 25 Post-processing | 67 Dotted vertical line |
| 30 Neural network | S1 First step |
| 31 Input layer | S2 Second step |
| 311 First bias | S3 Third step |
| 32 Hidden layer | S4 Fourth step |
| 321 Second bias | S5 Fifth step |
| 33 Output layer | S6 Sixth step |
| 40 Search graph | S7 Seventh step |

1. A method for generating a control program of a programmable logic controller in an automation system based on an AI pipeline containing at least one AI model with optional pre-processing of input data and/or post-processing of output data, the method comprising:
providing a latency model for predicting a computation time for executing an AI pipeline based on hardware configurations and software configurations, and a compatibility model for mapping AI pipeline functions to software configurations;
detecting a hardware configuration and a software configuration of the programmable logic controller; generating a set of AI pipeline candidates based on the compatibility model;
selecting an AI pipeline from the set of AI pipeline candidates by evaluating a performance of the AI pipeline candidates after training the AI pipeline candidates, taking into account a prediction of a computation time based on the latency model; and
generating a source code of the control program with the selected AI pipeline for execution on the programmable logic controller in the automation system.

2. The method according to claim 1, wherein the latency model determines a latency in the form of a numerical value which results from a sum of the runtimes of the executed AI pipeline functions.

3. The method according to claim 1, wherein the compatibility model generates a data structure in which AI pipeline functions are assigned equivalent functions in the software configuration.

4. The method according to claim 1, wherein the set of AI pipeline candidates is generated with the aid of at least one application-specific training data set.

5. The method according to claim 4, wherein a one-shot neural architecture search method is used to generate and train the set of AI pipeline candidates.

6. The method according to claim 1, wherein the generalizing capability of the AI pipeline is taken into account when selecting the AI pipeline from the set of AI pipeline candidates.

7. The method according to claim 6, wherein the Pareto optimality of the AI pipeline is taken into account when selecting it from the set of AI pipeline candidates.

8. The method according to claim 1, wherein, when selecting the AI pipeline with a training data set, retraining is carried out to improve the generalizing capability.

9. The method according to claim 1, wherein, if, when selecting the AI pipeline from the set of AI pipeline candidates, no pipeline candidate meets a specified latency requirement, an adjustment of the hardware configuration and/or the software configuration is carried out.

10. The method according to claim 1, wherein AI models for the AI pipeline candidates are selected from the group of neural networks, statistical models, support vector machines, decision trees, and/or random forests.

11. A method for operating an automation system comprising generating a control program of a programmable logic controller of the automation system according to claim 1, and further comprising:
loading the source code of the control program onto the programmable logic controller, executing the control program to carry an automation task.

12. An automation system for carrying out an automation task, operated using the method according to claim 11.
